(19) United States
(12) Patent Application Publication
(10) Pub. No.: US 2012/0052162 A1
(43) Pub. Date: Mar. 1, 2012

(54) CONVENIENCE FOOD PRODUCT

(76) Inventor: Paul Goulart, San Diego, CA (US)

(21) Appl. No.: 13/218,157

(22) Filed: Aug. 25, 2011

Related U.S. Application Data
(60) Provisional application No. 61/378,496, filed on Aug. 31, 2010.

(51) Int. Cl. B65D 81/34; A23P 1/12; B65D 81/32

(52) U.S. Cl. 426/107; 426/120; 426/514

(57) ABSTRACT

A convenience food product is described having a configuration optimized for rapid microwave heating and providing an integrated storage area for complementary consumables.

### CROSS-REFERENCE TO RELATED APPLICATIONS

This application claims the benefit of U.S. Provisional Patent Applications 61/378496, filed Aug. 31, 2010, entitled “Convenience Food Product”, currently pending, by the same inventor and hereby incorporated by reference.

### BACKGROUND OF THE INVENTION

1. Technical Field

The present invention relates to a frozen shell of edible material to which other edible material is added and which is subsequently processed to form a convenience food product.

2. Related Background Art

Convenience foods—products requiring minimum customer preparation—have experienced increased demand in response to today's busy lifestyles. Frozen or hermetically packaged products that require only a modest amount of heating in a microwave oven to make them ready for consumption are among the most popular. In particular, frozen products such as smoothies and soups fill a need for a quick meal having balanced nutrition with exceptional flavor. Frozen soups are typically heated in a microwave oven until piping hot, wherein they are ready to be consumed. Frozen smoothies, on the other hand, are usually microwave heated until partially melted, wherein a stirrable semiliquid state is achieved. Frequently, consumers add nonfrozen consumables to the heated product to enhance flavor, texture or nutritional value. For example, croutons, crackers, cheese and vitamin supplements may be added to the heated soup product, whereas dried fruit, granola, nuts and vitamin supplements may be added to a partially melted smoothie product. Although numerous examples of multi-component frozen convenience foods exist in the marketplace, they are relatively homogeneous with the ingredients of the primary product and invariably limited in the scope of complementary materials offered.

Thus, there is a need for a convenience food product offered in a configuration that is easily processed in a microwave oven and including a broad range of complementary consumables that enhance the consumer's experience.

### DISCLOSURE OF THE INVENTION

A convenience food product is described having a configuration optimized for rapid microwave heating and providing an integrated storage area for complementary consumables. The frozen product is manufactured in the form of a hollow cylinder, with or without an end cap of frozen product at one end. The cylindrical shape promotes rapid and even heating in a microwave oven and further provides a cavity for integrated storage of complementary consumables during shipping and while displayed for sale. In one embodiment the cylinder is tapered at one end. Nonlimiting examples of the material used in the frozen product include ice cream, frozen yogurt, frozen fruit juice, and frozen soup base. Nonlimiting examples of complementary consumables include granola, nuts, fresh or dried fruit, cereal, cookie pieces, croutons and crackers.

Exemplary processes for manufacturing the convenience food product are also described.

### BRIEF DESCRIPTION OF THE DRAWINGS

FIG. 1A shows an exploded view of one embodiment of the invention.

FIG. 1B shows an assembled view of the embodiment of FIG. 1A.

FIG. 2 shows an assembled view of an alternative embodiment of the invention.

FIG. 3 shows a molding method for producing the product.

FIG. 4A shows an exploded view of one embodiment of the molded product having an integrated storage container.

FIG. 4B shows an assembled view of the embodiment of FIG. 4A.

FIG. 5 shows one extrusion method for forming the product.

FIG. 6 shows an alternative extrusion method for forming the product.

FIG. 7A shows an exploded view of one embodiment of the extruded product having an integrated storage container.

FIG. 7B shows an assembled view of the embodiment of FIG. 7A.

FIG. 8 shows an embodiment of the alternative extrusion method of FIG. 6, which allows for the formation of a product configuration having multiple constituents.

### DETAILED DESCRIPTION

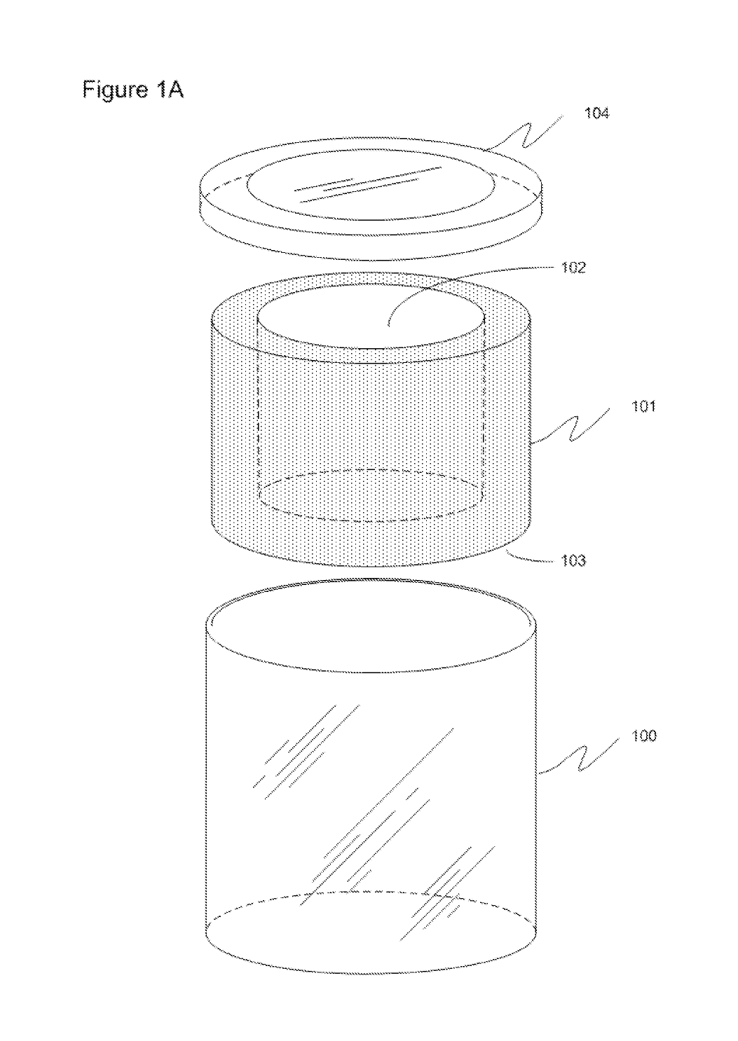

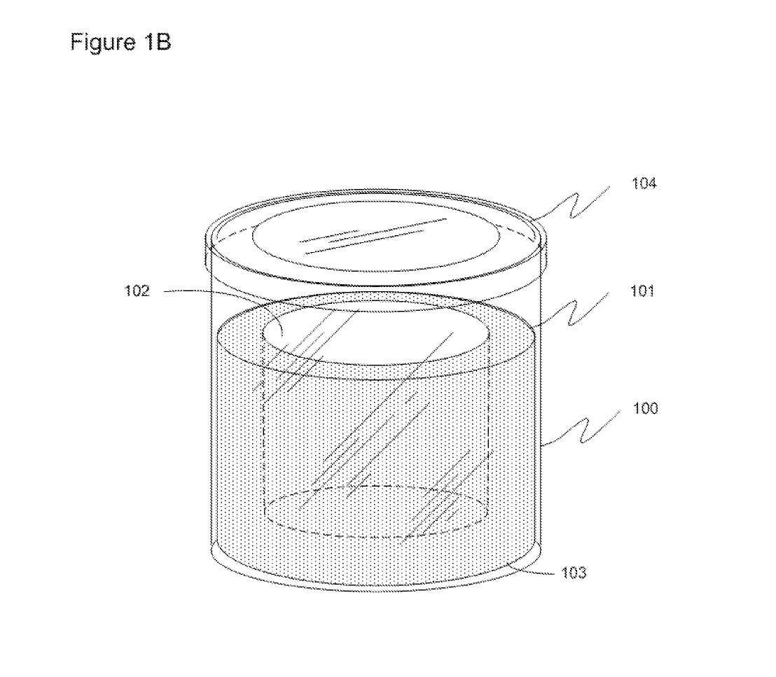

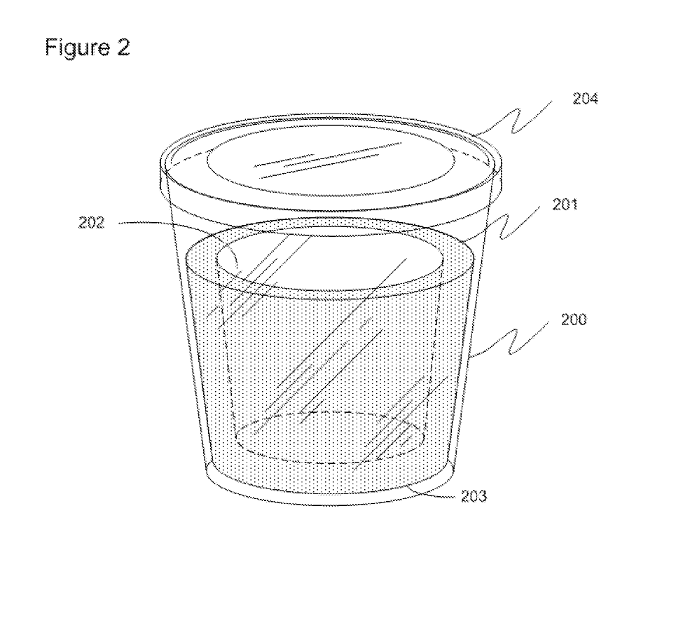

FIG. 1A illustrates one embodiment of the invention. FIG. 1A shows an exploded view that includes a container 100, a cylinder of frozen product 101 having a cavity 102 and with or without a cap of frozen material at the base 103, and a lid 104 for the container. FIG. 1B shows an assembled view of the embodiment shown in FIG. 1A. This product configuration could be sold by a vendor who provides complementary consumables to cavity 102 from bulk containers per customer demand. In another embodiment, not shown, the container 100 and the cylinder 101 are a right polygonal cylinder rather than the right circular cylinder as shown. FIG. 2 shows an assembled view of an alternative embodiment of the product in which container 200 and frozen product cylinder 201 are both tapered at one end.

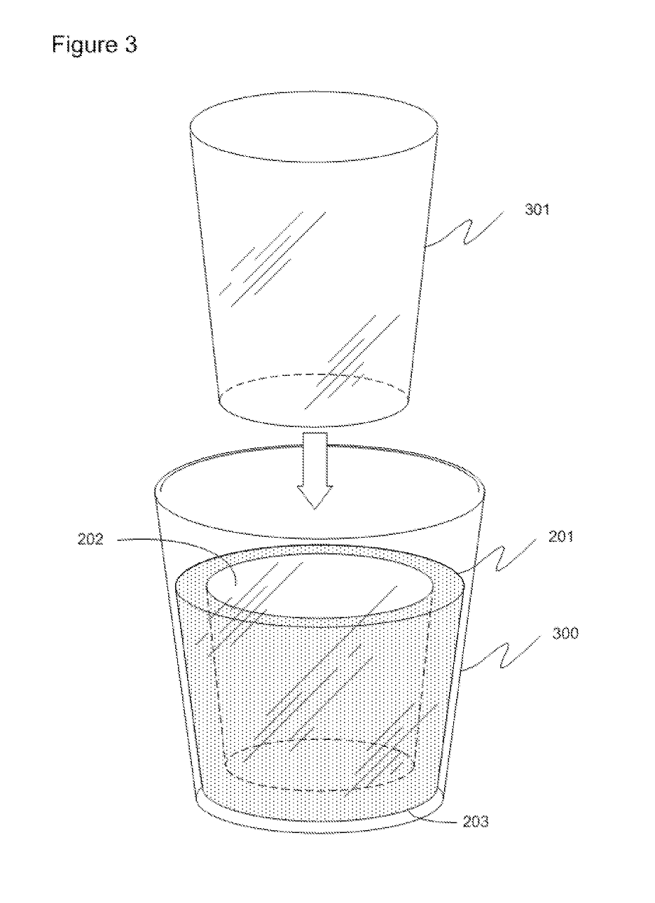

FIG. 3 illustrates a molding method for producing one embodiment of the frozen product cylinder 201. In this embodiment an outer mold member 300 is partially filled with liquid material and inner mold member 301 is aligned within member 300 to form the shape of cylinder 201, which may or may not include a thickness of liquid material at the base 203. The assembly is frozen by techniques that are well known in the art thus producing the frozen cylinder 201. In a separate embodiment, outer mold member 300 is container 200. It will be understood by one skilled in the art that a plurality of outer 300 and inner 301 mold members can be filled and frozen simultaneously in a batch manufacturing process. The tapered shape of mold members 300 and 301 is preferred in one embodiment to facilitate unmolding of the finished frozen product.

In an alternative embodiment (not illustrated), vertical spacers are attached to inner mold member 301 to separate the frozen cylinder 201 into a number of vertical sections during manufacture. These individual sections are separated after unmolding of the frozen product and combined with one or more frozen product cylinder sections formed from different product materials to form a multi-constituent frozen product cylinder.

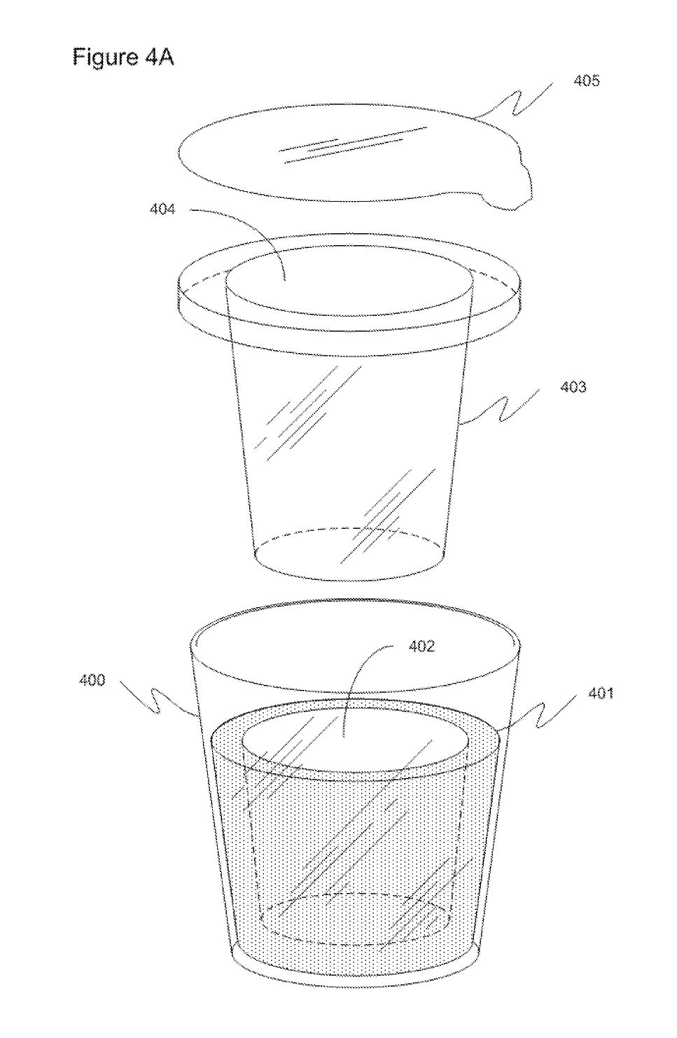

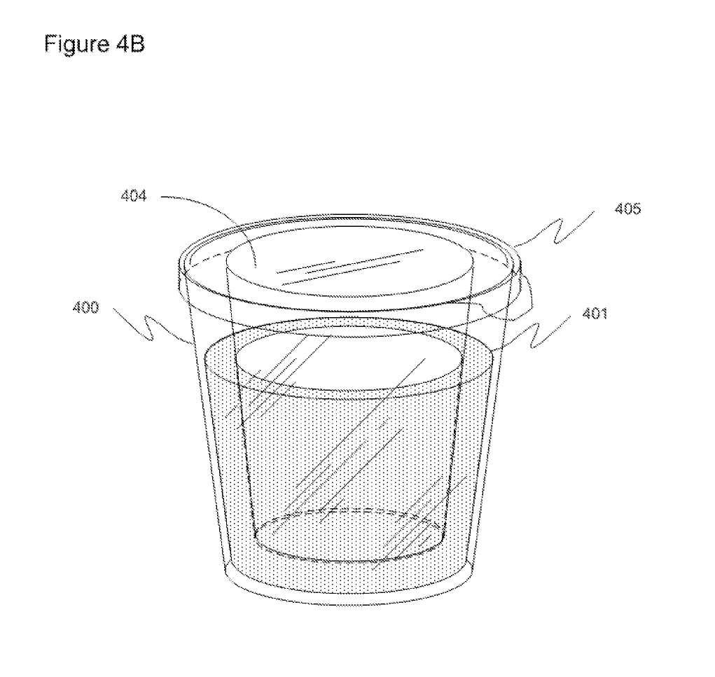

FIG. 4A shows an exploded view of another embodiment of the invention produced by molding that includes container 400 containing frozen cylinder 401 that includes a central cavity for containing complementary consumables. A separate container for the complementary consumables 403 fits within cavity 402 and seals to the top of container 400 to protect product 401 from contamination. A separate plastic cover 405 attaches to the upper surface of container 403 to provide a seal for the complementary consumables. An assembled view of the embodiment is shown in FIG. 4B. In this embodiment, various formulations of the frozen product 401 may be combined with servings of various complementary consumables stored in 403 and offered for sale in an integrated format. Nonlimiting examples of the material used in the frozen product include ice cream, frozen yogurt, frozen fruit juice, and frozen soup base. Nonlimiting examples of complementary consumables include granola, nuts, fresh or dried fruit, cereal, cookie pieces, croutons and crackers. In another embodiment the frozen product is a frozen confectionary ice product and the complementary consumable is ice cream or a yogurt product.

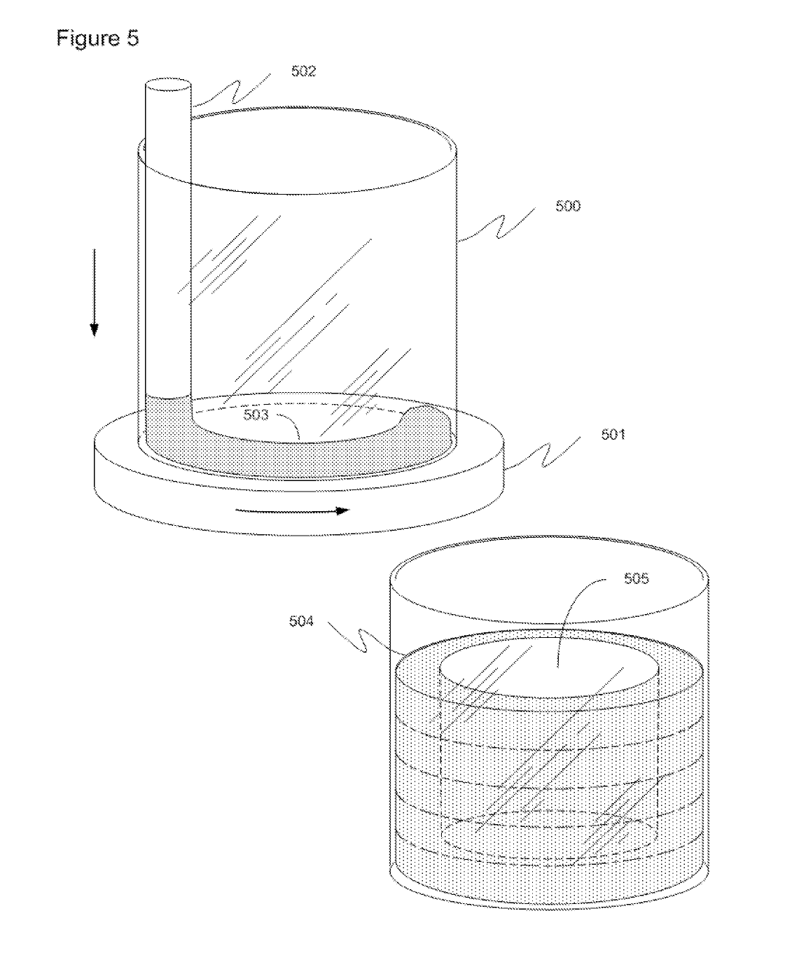

FIG. 5 illustrates one method of forming the frozen product using an extrusion method. Semifrozen product 503 is pumped through a dispensing tube 502 oriented near the wall of container 500 that is mounted on a rotating base 501. The base 501 is also lowered with respect to the dispensing tube 502 while rotating in order to form a uniform cylinder of semifrozen material 504 having an internal cavity 505. The filled container 500 is then transferred to a freezer unit to complete freezing of the product 504.

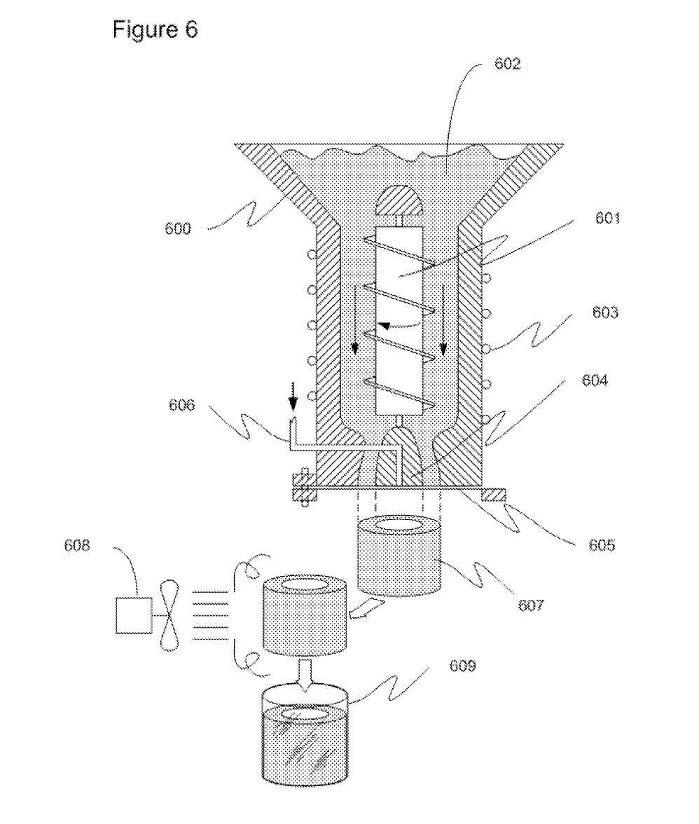

FIG. 6 illustrates the preferred embodiment extrusion technique for producing the frozen product. In this embodiment semifrozen product 602 is added to the receiving end of vertical extrusion cylinder 600 cooled, for example, by coolant flowing in external cooling coils 603. The product is fed through the cylinder by rotating screw 601 and forced through the circularly cylindrical die 604 to directly form an extruded cylinder of frozen material. Compressed gas is optionally fed through the center of die 604 through a gas supply tube 606 to maintain the dimension of the internal cavity in frozen product cylinder 607. Frozen product cylinder 607 is cut to length using a hot wire 605 that passes beneath the outlet of the extrusion die 604. The partially frozen product 607 is subsequently fully frozen by external cooling means 608 and is loaded into container 609 by automated means.

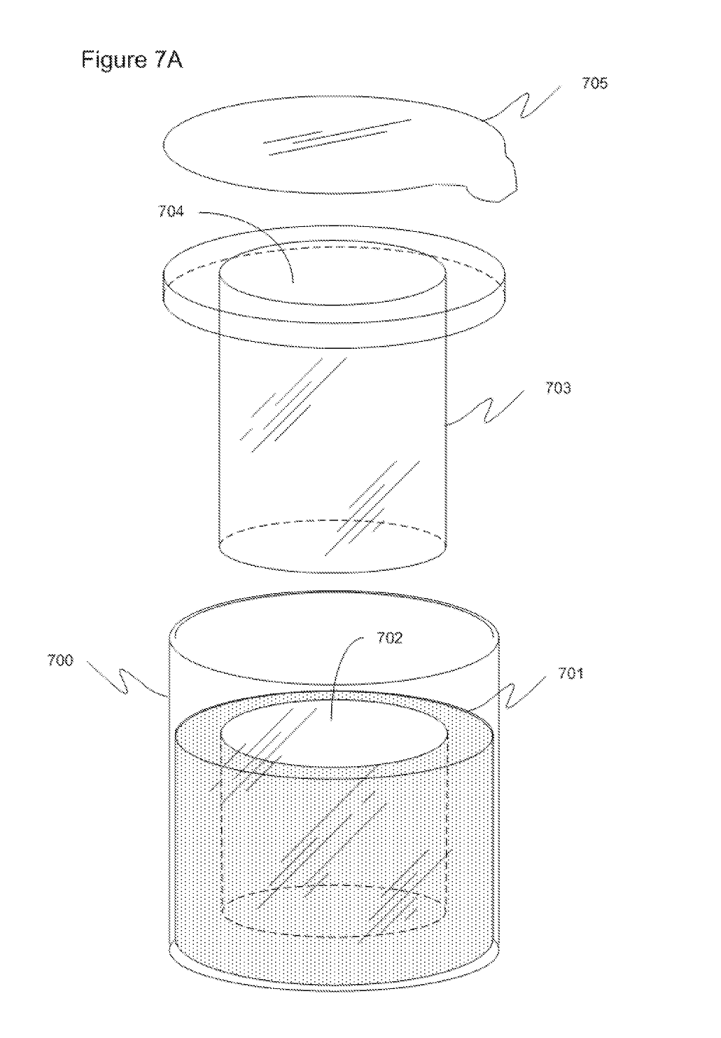

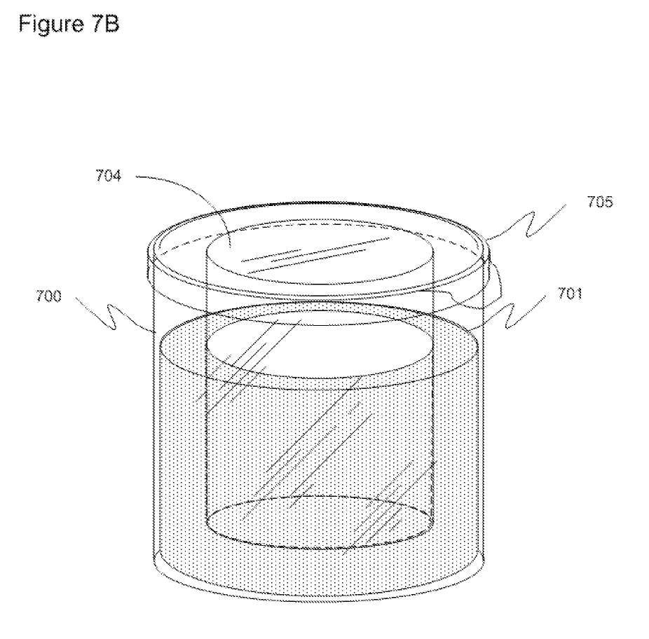

FIG. 7A shows an exploded view of the embodiment of the product formed using the extrusion processes of either FIG. 5 or FIG. 6 that includes container 700 containing frozen cylinder 701 that includes a central cavity 702 for containing complementary consumables. A separate container for the complementary consumables 703 fits within cavity 702 and seals to the top of container 700 to protect product 701 from contamination. A separate plastic cover 705 attaches to the upper surface of container 703 to provide a seal for the complementary consumables. An assembled view of the embodiment is shown in FIG. 7B. In this embodiment, various formulations of the frozen product 701 may be combined with servings of various complementary consumables stored in 703 and offered for sale in an integrated format.

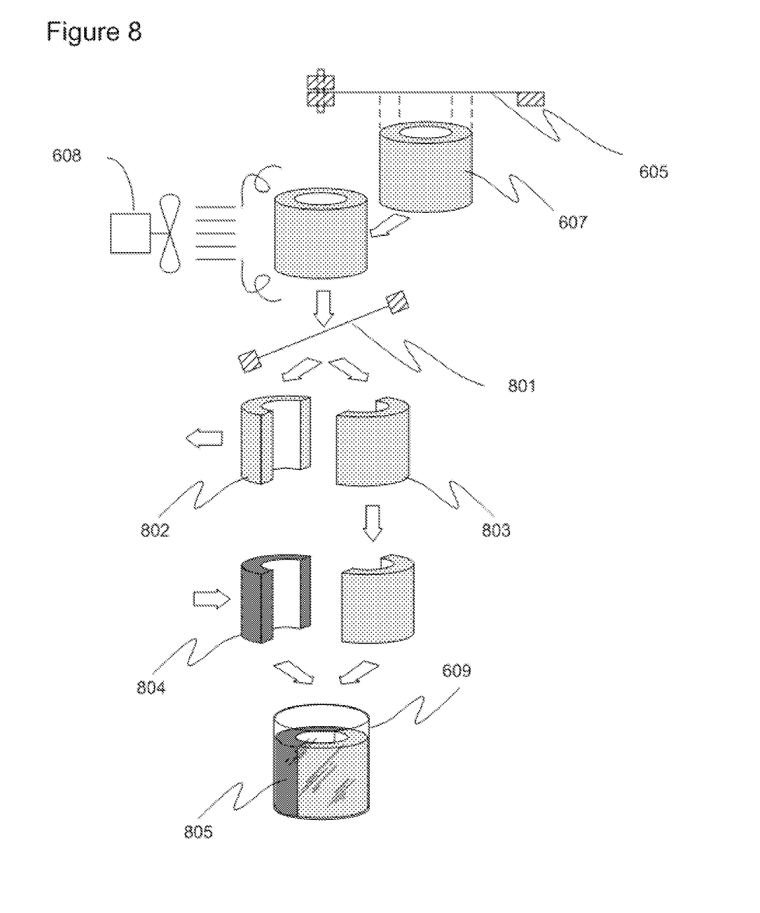

FIG. 8 shows an embodiment of the extrusion technique of FIG. 6 that allows for the formation of a product configuration having multiple constituents. After extrusion and horizontal slicing of the frozen product cylinder 607 by the hot wire 605, the fully frozen product cylinder is sliced vertically using a second hot wire assembly 801 to form two or more cylindrical sections. A selected section 803 is passed forward for further processing whereas the unselected section 802 is removed and stored for later use. The selected frozen product cylinder section is then combined with one or more frozen product cylinder sections 804 formed from a different product material to form a multi-constituent frozen product cylinder 805 that is loaded into container 609 by automated means.

In an alternative embodiment (not illustrated) circular cylindrical extrusion die 604 is replaced with a die that extrudes a section of a circular cylinder directly. In this embodiment the extrusion can optionally be performed in a horizontal orientation. As in FIG. 8, a directly extruded or molded frozen product cylinder section 803 is then combined with one or more frozen product cylinder sections 804 formed from different product materials to form a multi-constituent frozen product cylinder 805 which is loaded into container 609 by automated means. In another embodiment (not illustrated) the extruded cylindrical sections are sections of a polygonal cylinder rather than a circular cylinder.

### SUMMARY

A convenience food product is described having a configuration optimized for rapid microwave heating and providing an integrated storage area for complementary consumables. The frozen product is manufactured in the form of a hollow cylinder, with or without an end cap of frozen product at one end. The cylindrical shape promotes rapid and even heating in a microwave oven and further provides a cavity for integrated storage of complementary consumables during shipping and while displayed for sale. In one embodiment the cylinder is tapered at one end.

Preferred processes for manufacturing the convenience food product are also described.

What is claimed is:

1. A convenience food product comprising:
a) a frozen food product formed in the shape of a cylinder having a central cavity and provided in a container,
b) complementary consumables delivered within said central cavity and capable of being mixed with said frozen food product when thawed.

2. The convenience food product of claim 1 wherein said container is microwave-compatible.

3. A method of producing a convenience food product comprising the step of molding said frozen food product in the shape of a cylinder.

4. A method of producing a convenience food product comprising the step of extruding said frozen food product in the shape of a cylinder.

5. The method of producing a convenience food product according to claim 3 further comprising forming a multi-constituent frozen food product by a) forming two or more cylindrical sections formed from different product materials and b) combining said cylindrical sections to form a complete multi-constituent cylinder of frozen food product.

6. The method of producing a convenience food product according to claim 4 further comprising forming a multi-constituent frozen food product by a) forming two or more cylindrical sections formed from different product materials and b) combining said cylindrical sections to form a complete multi-constituent cylinder of frozen food product.

7. The method of claim 5 wherein said cylindrical sections are sections of a polygonal cylinder.

8. The method of claim 6 wherein said cylindrical sections are sections of a polygonal cylinder.
